(19) United States
(12) Patent Application Publication
(10) Pub. No.: US 2006/0039564 A1
(43) Pub. Date: Feb. 23, 2006

(54) Security for device management and firmware updates in an operator network

(76) Inventor: Bindu Rama Rao, Laguna Niguel, CA (US)

Correspondence Address: Kevin Borg;McAndrews, Held & Malloy, Ltd., 500 W. Madison St., Chicago, IL, 60661, US

(21) Appl. No.: 11/247,463

(22) Filed: Oct. 11, 2005

Related U.S. Application Data
(63) Continuation of application No. PCT/US01/44034, filed on Nov. 19, 2001.
(60) Provisional application No. 60/249,606, filed on Nov. 17, 2000.
(60) Provisional application No. 60/619,361, filed on Oct. 15, 2004.

(51) Int. Cl. H04K 1/00

(52) U.S. Cl. 380/270; 455/410

(57) ABSTRACT

A SIM/Smartcards based approach to security within an operator's network (OMA device management system), by providing certificates to mobile devices as a way of authenticating the servers. A root certificate is stored in the SIM/Smartcard of each mobile device and accessed by the electronic device when the SIM/Smartcard is inserted into programmed card reader. Typically, in a OMA device management system, there are device management (DM) servers, mobile variance platform (MVP) server and generator; each are provisioned with a unique certificate that refers to a root certificate issued or associated with the operator, device management certificate (DMCert), mobile variance platform certificate (MVPCert) and provider certificate (ProviderCert), respectively. The mobile device authenticates each server session for Bootstrap provisioning and update package sessions originated by the servers, by verifying the root certificate with the certificates of the servers that accompany Bootstrap provisioning and update package messages.

The present application is a continuation of PCT Application with publication number WO/02/41147 A1, PCT number PCT/US01/44034, filed 19 Nov. 2001, which in turn is based on a provisional application 60/249,606 filed 17, Nov. 2000, both of which are incorporated by reference in their entirety. It is also based on U.S. provisional patent application Ser. No. 60/619361, with attorney docket number 101USMD105 and 16407US01, titled ‘SECURITY FOR DEVICE MANAGEMENT AND FIRMWARE UPDATES IN AN OPERATOR NETWORK’, filed on Oct. 15, 2003, and on U.S. provisional patent application with Ser. No. 60/422048, with attorney docket number 14897US02 and 101USMD12, titled ‘SECURITY SYSTEM FOR COMMUNICATING DATA BETWEEN A MOBILE HANDSET AND A MANAGEMENT SERVER’, filed on Oct. 29, 2002. Both the applications 60/619361 and 60/422048 are hereby incorporated by reference in their entirety.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

1. Field of the Invention

The present invention relates generally to the secure management of mobile devices and specifically to secure firmware updates of devices.

2. Related Art

Electronic devices, such as mobile phones and personal digital assistants (PDA's), often contain firmware and application software that are either provided by the manufacturers of the electronic devices, by telecommunication carriers, or by third parties. If firmware or firmware components are to be changed in electronic devices, it is often very tricky to update the firmware components. Particularly, any code of functions that is employed to update firmware or firmware components themselves may have to be changed or updated. Currently, there are no standards for the secure transfer of update packages from the generator to the mobile devices. There are no easy, standard secure ways to send device management messages to the mobile devices.

There are no easy ways to authenticate all those servers in the operator's network by a mobile device. There are no simple, efficient ways to authenticate certificates presented by a server to a mobile device. It is often not possible for a mobile device to seek the help of a certificate authority in order to verify certificates presented by a server, such as a DM server or a download server.

In general, several different servers try to access a mobile phone and try to update applications, configurations, etc. Trusting such servers is a problem that can open the mobile phone to hacking or access by unauthorized servers. Which server to test and which server to not trust is a decision that a device often may have to make, but cannot make as the logistics of doing so are overwhelming and the necessary infrastructure often does not exist in an operator network. This problem is likely to be exacerbated by the introduction of new mobile devices that are capable of over-the-air downloads, and by the introduction of new service providers into the network. Determining which of these service providers are legitimate is an important problem that has not yet been adequately addressed in the mobile phone industry.

### BRIEF SUMMARY OF THE INVENTION

The present invention is directed to apparatus and methods of operation that are further described in the following Brief Description of the Drawings, the Detailed Description of the Invention, and the Claims. Features and advantages of the present invention will become apparent from the following detailed description of the invention made with reference to the accompanying drawings.

### BRIEF DESCRIPTION OF THE DRAWINGS

FIG. 1 is a perspective block diagram of an OMA device management system wherein each server is given a certificate and a mobile handset has a SIM/Smartcard with certificates, the mobile handset being capable of authenticating the servers when they communicate with the mobile handset;

FIG. 2 is a perspective block diagram of an OMA device management system wherein a DM server, an MVP management server and a generator are all provisioned with the same certificate ‘OperatorCert’, and wherein the SIM/Smart card in a mobile handset is also provisioned with only one certificate, the OperatorCert’, for server authentication purposes;

FIG. 3 presents a flow diagram of an exemplary scenario wherein the Smartcard is provisioned with an operator's root certificate and the DM server sends a ServerCert to the device with each DM message for authentication and verification;

FIG. 4 presents another flow diagram of an exemplary scenario wherein the Smartcard is provisioned with an operator's root certificate, the DM server sends a server certificate to the device with each DM message for authentication and verification, and the update package communicated by a generator to the DM server or MVP management server is signed with a provider certificate that refers back to the operator's root certificate; and

FIG. 5 is a flow diagram illustrating the method used in the mobile handset during a secured over-the-air Bootstrap provisioning and device management.

### DETAILED DESCRIPTION OF THE INVENTION

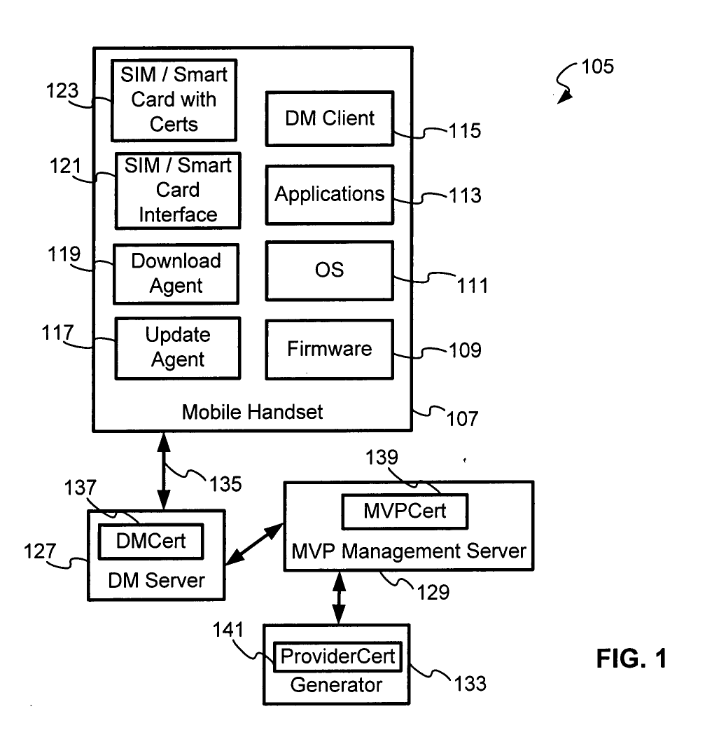

FIG. 1 is a perspective block diagram of an OMA device management system 105 wherein each server is given a certificate and a mobile handset 107 has a SIM/Smartcard with certificates, the mobile handset 107 being capable of authenticating one or more servers when they communicate with the mobile handset 107. The OMA device management (OMA DM) system 105 comprises a mobile handset 107, a device management (DM) server 127, a mobile variance platform (MVP) management server 129 and a generator 133, all are communicatively coupled by a communication infrastructure (not shown). The mobile handset 107 comprises of a SIM/Smart card with certificates 123, SIM/Smartcard interface 121, a download agent 119, an update agent 117, a device management (DM) client 115, applications 113, an operating system (OS) 111 and a firmware 109. The mobile handset 107 and the DM server 127 are communicatively coupled by a communication link 135. The DM server 127, the MVP management server 129 and the generator 133 each have a unique certificate that refers to a root certificate issued or associated with the operator, device management certificate (DMCert) 137, mobile variance platform certificate (MVPCert) 139 and provider certificate (ProviderCert) 133, respectively.

An operator working within the OMA device management system 105 provides the SIM/Smart card 123 and the certificates provisioned in it. The download agent 119 is typically responsible for authenticating the servers, by retrieving the certificates provisioned within the SIM/Smartcard 123. The DM client 115 interacts with the DM server 127 by employing a DM protocol and appropriate certificates for authentication. The update agent 117 is capable of authenticating the origin/source of update packages that are used to update a firmware 109, over-the-air.

The present invention solves at least two fundamental security problems that need to be solved for device management of mobile devices—security for bootstrap provisioning and security for device management sessions. The present invention addresses both these problems in an efficient manner that not only makes deployments easier but also the management of such deployments simpler.

In general, the present invention recommends an approach to security that is based on the use of SIM/Smart Cards as a means of providing certificates that are used for authenticating servers in an operator network, such as a cellular wireless network that comprises the OMA device management system 105.

The advantages of the approaches recommended in the present invention are several. The proposed approach makes up for the current OMA-DM deficiencies, such as insufficient security in Bootstrap provisioning and the incorporation of a SIM/SC for not only authenticating OTA provisioning but also for authentication during OMA-DM sessions. In particular, it employs the SIM/Smart card as a Certificate Authority capable of providing a root certificate.

Within an OMA device management system 105, two fundamental security problems have to be solved for device management, namely security for Bootstrap provisioning and security for device management sessions. The present invention addresses both these problems. According to the present invention, an approach is presented based upon the use of SIM/Smartcards as a means of providing certificates that are used for authenticating servers in the OMA device management system 105, thus achieving secured over-the-air device management and over-the-air Bootstrap provisioning. The advantages of the approaches presented, according to the present invention, are several. This approach makes up for the current OMA DM deficiencies, such as insufficient security in Bootstrap provisioning and the incorporation of a SIM/Smartcard for not only authenticating over-the-air provisioning but also for authentication during OMA DM sessions. In particular, this approach employs the SIM/Smart card as a Certificate Authority capable of providing a root certificate.

According to the present invention, an operator as a subscriber certificate typically issues the SIM/Smartcard 123. The operator within a OMA device management system 105 incorporates root certificate into each SIM/Smartcard 123 that is dispensed. A certificate on the SIM/Smartcard 123, one that is the certificate of the root, called the RootCert, makes it possible to authenticate any certificate that a DM server 127, or any other server in the operator network, such as a download server, might present to a device, such as a mobile handset 107. The operator provides this RootCert, which may be in addition to subscriber specific credentials provided by the operator.

When the DM server 127 intends to send messages (update packages, for example), the private key or a certificate installed on the DM server 127 is presented to the DM client 115 in the device, such as a mobile handset 107, along with digitally signed messages. When the DM server 127 sends a message to the DM client 115, the message is digitally signed and the associated certificate, called ServerCert that may be sent along with the signed message.

The DM client 115, or any other client in the device such as a mobile handset 107, is capable of retrieving the RootCert provided by the SIM/Smart card 123. Using the root cert, the DM client 115 is able to authenticate the ServerCert received. The DM client 115 in the device (a mobile handset 107, for example), typically employs a standard interface to a SIM/Smartcard 121 to retrieve information, such as certificates, stored in the SIM/Smartcard.

The DM client 115 (or other components) in the employs the RootCert retrieved from the SIM/Smartcard 123 to verify the ServerCert presented by the DM server 127 or another server in the OMA device management system 105. Thus, if the root of the ServerCert provided to the DM server 127 is provided in the SIM/Smartcard 123, the device such as a mobile handset 107 is capable of authenticating the DM server 127 and trusting the DM server 127 almost as if a Certificate Authority were available.

The SIM toolkit may be employed to provision the DM server's certificate—ServerCert, in to the Smartcard. Further, the DM Server's certificate may be sent to a DM client 107 during each device management session. If the DM Server 127 sends a certificate with each device management message, it may employ the credential element of a device management message. In such a scenario, only the RootCert is provisioned in the Smartcard.

A device, such as the mobile handset 107 may choose to cache the RootCert for the DM server 127 rather than retrieve it frequently from the SIM/Smartcard 123. Similarly, the device may cache the ServerCert received from the DM server 127 in the device.

A secure Bootstrap of the device such as a mobile handset 107 may be achieved if the SIM/Smartcard 123 provided by an operator is provisioned with the RootCert and the incoming provisioning messages are accompanied with the ServerCert. Alternatively, both the RootCert and the ServerCert may be provisioned into the SIM/Smartcard 123 of the device and the device management messages in each session are accompanied by message authentication code (MAC) or HMAC that are based on the ServerCert.

Further, the ProviderCert may be employed for signing update packages generated by a generator, that refers back to the RootCert. The device then employs the RootCert to authenticate the source of the update package, i.e. the software originator/provider. Thus, the proof of origin is provided.

Thus, device management sessions may be authenticated when a ServerCert accompanies the device management message. Again, it is not necessary that ServerCert accompany messages during each session if the ServerCert is provided to the device through some provisioning or pre-provisioning method, or provided in the SIM/Smart Card 123.

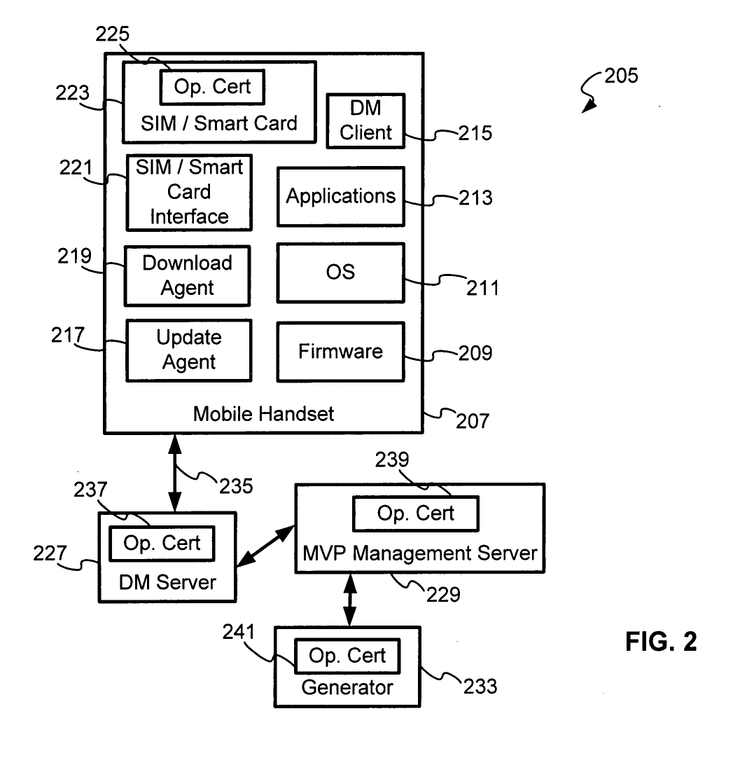

These three certificates, namely ProviderCert, MVPCert and DMCert, may be the same one (as described with reference to the FIG. 2) or different ones. These three certificates may be different ones issued by the operator with a root ‘RootCert’ that is owned or assigned to the operator. In addition, a device (mobile handset) can be provisioned with a public key for these certificates. Further, if the device is provisioned with the root certificate—RootCert when the device is presented with any of the certificates ProviderCert, MVPCert and DMCert, the device is able to retrieve the RootCert from its SIM card and verify the other certificate(s) received, or digests received, i.e. authenticate the other servers as the source.

The ProviderCert may also be associated with an OEM (OEMCert) rather than with the operator (OperatorCert). In this scenario, the device will have to retrieve an associated public key (possibly pre-provisioned by the OEM at a factory), either from the SIM/Smartcard 123 or the memory of the device to authenticate the update packages signed by the OEMCert.

If the three certificates ProviderCert, MVPCert and DMCert are the same certificate ‘OperatorCert’ as described with reference to the FIG. 2, then the SIM/Smart card 123 needs to be provisioned with only one certificate for server authentication purposes—the OperatorCert. The root certificate ‘RootCert’ of the OperatorCert may also supplement this OpertaorCert in the SIM/Smartcard 123. Thus, using the OperatorCert, the other servers are authenticated, and using the operator's root cert ‘RootCert’, the OperatorCert itself may be authenticated, if the device needs to do so.

FIG. 2 is a perspective block diagram of an OMA device management system wherein a DM server 227, an MVP management server 229 and a generator 233 are all provisioned with the same certificate ‘OperatorCert’, and wherein the SIM/Smart card in a mobile handset 207 is also provisioned with only one certificate, the OperatorCert’, for server authentication purposes. The OMA device management system 205 comprises of a mobile handset 207, device management (DM) server 227, mobile variance platform (MVP) management server 229 and generator 233, all are communicatively coupled by a communication infrastructure (not shown). The mobile handset 207 comprises of a SIM/Smart card 223, SIM/Smartcard interface 221, download agent 219, update agent 217, device management (DM) client 215, applications 213, operating system (OS) 211 and firmware 209. The SIM/Smartcard 123 is provisioned with a root certificate (RootCert—not shown) with in a operator's certificate (OperatorCert or Op. Cert) 225. The mobile handset 207 and the DM server 227 are communicatively coupled by a communication link 235. The DM server 227, the MVP management server 229 and the generator 233 each have same certificate that refers to a root certificate issued or associated with the operator, operator's certificate (OperatorCert or Op. Cert) 237, 239 and 241, respectively.

Thus, using the OperatorCert, the servers DM Server 227, the MVP management server 229 and the generator 241 are authenticated, and using the operator's root certificate ‘RootCert’. The OperatorCert itself may be authenticated in the mobile handset 207, if the device needs to do so, using the root certificate of the OperatorCert (the RootCert) that is also pre-provisioned into the SIM/Smartcard 225.

The SIM/Smart Card 225 may comprise of more than the OperatorCert 225 and the operator's root cert ‘RootCert’—it may also contain the OEM's certificate for the public key to be employed to authenticate an update package signed by the OEM using the OEM's own certificate. Thus, the authentication of an update package may be conducted at more than one level: (a) Using the operator's OperatorCert to authenticate the operator as the source of distribution. This may be conducted after download completion, perhaps before saving or writing into flash (such as by a Handoff agent); and (b) Using the OEM's certificate to ensure that the OEM is the origin of the update package. The update agent may conduct this just before update.

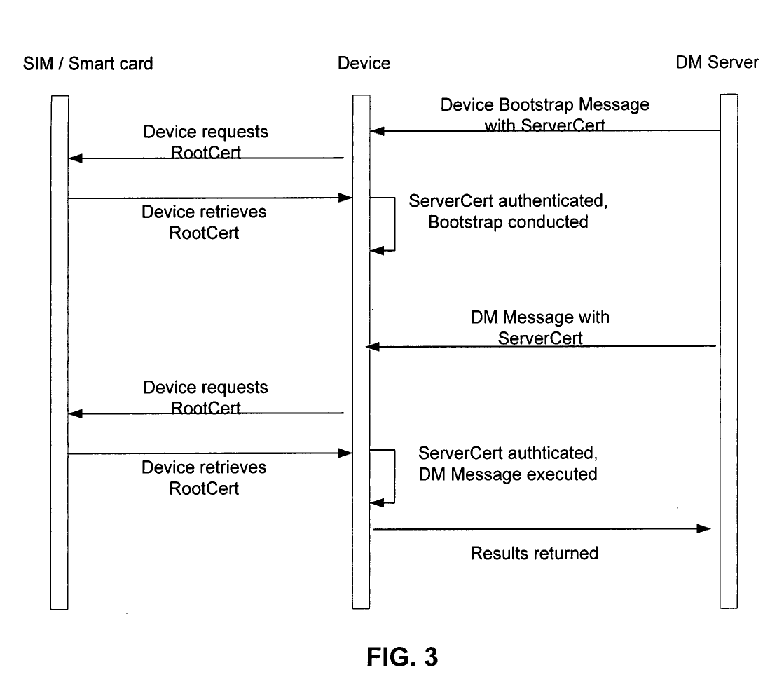

FIG. 3 presents a flow diagram of an exemplary scenario wherein the Smartcard is provisioned with an operator's root certificate and the DM server sends a ServerCert to the device with each DM message for authentication and verification. Assumptions made for this scenario are: (a) The smartcard is provisioned with the operator root (RootCert); (b) The DM client supports the required ciphering suites e.g. RSA_SHA1 etc.; (c) The DM server certificate (ServCert) will be sent along with the DM messages; and (d) There is a defined interface for communicating to the smart card from the device. For example, every time the DM Server makes an update the device looks for the root stored in the smart card to verify the servers certificate; the device can cache the DM server certificate, however the device must always ask the smart card to verify the certificate (using the root) before trusting anything in the cache.

The flowchart operation is as follows: Initially, the Device Management server (DM server) makes a request to perform device management operation on the device. For this, the DM server sends a device Bootstrap message with server certificate (ServerCert) to the device. Then, the device looks at the server certificate sent within the message and requests the SIM/Smartcard to send down the certificate(s) to verify the DM Server. That is, the device requests the SIM/Smartcard for the root certificate (RootCert) and retrieves the RootCert. Then the device authenticates the ServerCert and the Bootstrap is conducted. Thus, the device either accepts or rejects the request to perform device management operation based on the success of the verification procedure.

Then, once the Bootstrap is conducted, the DM server sends device management (DM) messages together with ServerCert. The device again requests the SIM/Smartcard for RootCert and retrieves it. Further, the device authenticates the ServerCert. Once the ServerCert is authenticated, the device executes the device management messages. Finally, the device returns the results back to the DM Server.

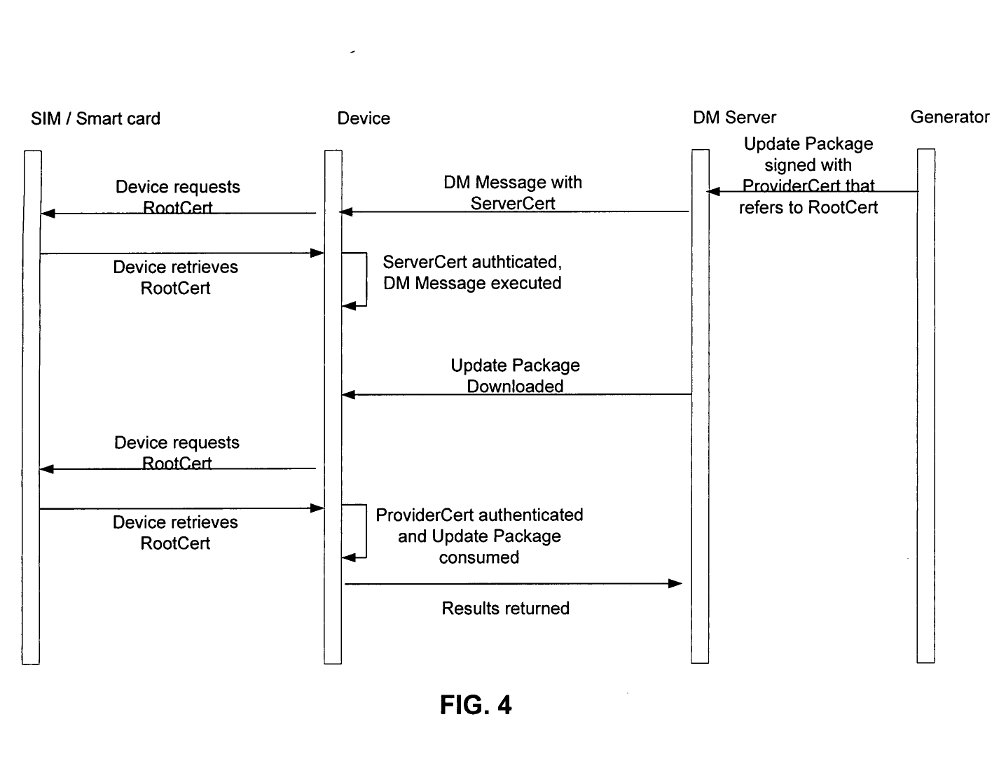

FIG. 4 presents another flow diagram of an exemplary scenario wherein the Smartcard is provisioned with an operator's root certificate, the DM server sends a server certificate to the device with each DM message for authentication and verification, and the update package communicated by a generator to the DM server or MVP management server is signed with a provider certificate that refers back to the operator's root certificate.

The exemplary scenario begins with the generator generating and sending update package signed with ProviderCert that refers to the RootCert of a mobile device to the DM server. The DM server signs a DM Message with ServerCert and sends it to the device. The device requests for the RootCert from the SIM/Smartcard, retrieves it and authenticates the ServerCert. Then, upon success of authentication, the device executes the DM Message. After that, the DM server sends the update package signed with ProviderCert, received from the generator, to the device. The device again verifies the authenticity of the update package by retrieving RootCert from the SIM/Smartcard. After a successful authentication, the device executes the update package and returns the results signed with RootCert.

The Smartcard provisioned is provisioned with an operator's root certificate, an MVP management Server and DM Server are provided with an MVPCert, and DMCert, respectively, both referring to the operator's root cert ‘RootCert’. A number of servers, such as those listed below, within an OMA device management system may be provisioned with a certificate that is derived from a root certificate ‘RootCert’ owned or assigned to an operator: (a) the generator that creates an update package—ProviderCert; (b) MVP Management Server—MVPCert; and (c) MVP DM Server—DMCert. An associated public key may be provisioned in a SIM/Smartcard provided to a user by an operator. In addition, the ‘RootCert’ owned or assigned to an operator may also be provisioned in the SIM/Smartcard.

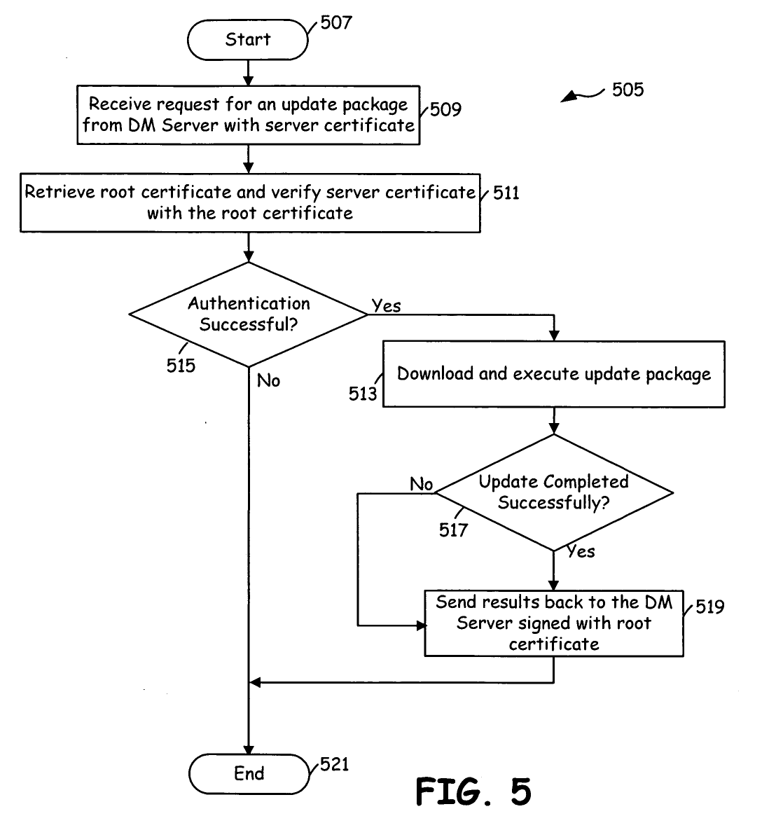

FIG. 5 is a flow diagram illustrating the method used in the mobile handset during a secured over-the-air Bootstrap provisioning and device management. The method performed during secured Bootstrap provisioning and device management starts at a block 507. Then, the mobile handset receives a request for an update package from the DM server with ServerCert, at a next block 509.

At a next block 511, the mobile handset, upon receipt of a DM Message signed with ServerCert, retrieves root certificate and verifies the authenticity of the ServerCert. Then, at a next decision block 515, the success of authenticity verification is decided. If not successful, the DM Message is rejected, and at a next block 521, the method ends.

If successful at the decision block 515, the DM messages are executed at a next block 513. The success or failure of the DM message execution is determined at a next decision block 517. Irrespective of success or failure at the decision block 517, appropriate results of the DM message execution in the mobile handset are sent back to the DM server at a next block 519. The DM server may initiate another Bootstrap provisioning and/or device management session in case of failure. Then, the method ends at the block 521.

Although a system and method according to the present invention has been described in connection with the preferred embodiment, it is not intended to be limited to the specific form set forth herein, but on the contrary, it is intended to cover such alternative, modifications, and equivalents, as can be reasonably included within the spirit and scope of the invention as defined by this disclosure and appended diagrams.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An electronic device with a programmed card reader operable to provide security in over-the-air bootstrap provisioning, the electronic device comprising:
a programmed card;
a root certificate stored in the programmed card that is accessed by the electronic device when the programmed card is inserted into programmed card reader;
the electronic device ensuring security during an over-the-air device management session with a remote server employing the root certificate;
the electronic device employing the root certificate to authenticate at least one of a message received from the remote server and a certificate received from the remote server.

2. The electronic device of claim 1, wherein the programmed card is one of a SIM Card or Smart Card.

3. The electronic device of claim 1, wherein the security in the over-the-air bootstrap provisioning comprises of the electronic device receiving authenticated bootstrap provisioning messages from a provisioning server wherein the authentication employs a provisioning server certificate based on the root certificate.

4. The electronic device of claim 3, wherein the bootstrap provisioning message is signed using a first certificate that is derived from and authenticated by the root certificate and wherein the first certificate accompanies the bootstrap provisioning message.

5. The electronic device of claim 3, wherein the bootstrap provisioning message is a SyncML based device management message received from a device management server.

6. The electronic device of claim 4, wherein the root certificate is employed to authenticate a device management session with a device management server.

7. The electronic device of claim 6, wherein the device management message is signed using a second certificate that is derived from and authenticated by the root certificate and wherein the second certificate accompanies the bootstrap provisioning message.

8. The electronic device of claim 7, wherein the root certificate is retrieved from the programmed card by a DM client in the electronic device to authenticate a device management server.

9. The electronic device of claim 8, wherein the root certificate is retrieved from the programmed card by a download agent in the electronic device to authenticate a download server.

10. An OMA device management (OMA DM) system that facilitates secured over-the-air bootstrap provisioning and over-the-air device management, comprising:
a mobile handset provisioned with a root certificate;
a device management server, communicatively coupled to the mobile handset and having a device management server certificate; the device management server being capable of providing security during over-the-air device management sessions;
a mobile variance platform management server, communicatively coupled to the device management server and having a mobile variance platform certificate; and
a generator, communicatively coupled to the mobile variance platform management server, having a provider certificate and being adapted to generate update packages for the mobile handset.

11. The OMA device management system of claim 10, wherein the root certificate provisioned in the mobile handset is issued by an operator.

12. The OMA device management system of claim 11 wherein each of the device management server certificate, mobile variance platform certificate and provider certificate refer to the operator's root certificate provisioned in the mobile handset.

13. The OMA device management system of claim 11 wherein the device management server certificate is sent to the mobile handset, along with the device management messages for authentication and verification.

14. The OMA device management system of claim 11 wherein the update package generated by the generator is signed with a provider certificate that refers back to the operator's root certificate.

15. The OMA device management system of claim 11, wherein the secured over-the-air device management and over-the-air bootstrap provisioning comprises of the root certificate provisioned in the mobile handset authenticating the device management server that presents the bootstrap provisioning and device management messages to the mobile handset.

16. A method of conducting secure device management, the method comprising:
retrieving a root certificate from a smartcard in a device;
employing the root certificate to verify a server certificate presented by a server;
processing data provided by the server; and
sending results back to the server.

17. The method of claim 16, wherein the secure device management comprises of secured over-the-air bootstrap provisioning or over-the-air device management sessions.

18. The method of claim 16, wherein the employing the root certificate to verify a server certificate comprises of using a root certificate provisioned in the mobile handset that is issued by an operator to authenticate the device management server that sends device management messages and the bootstrap provisioning messages.

19. The method of claim 16, wherein the processing data provided by the server comprises:
setting parameters and configuration from the bootstrap provisioning messages; and
executing device management messages.

20. The method of claim 16 wherein the sending of results comprises signing the results with the root certificate.

21. The method of claim 16 wherein the employing comprises verifying that the server certificate is authentic.

22. The method of claim 21 wherein the server is a firmware update management server.

23. The method of claim 21 wherein the server is a provisioning server.
